(19) United States
(12) Patent Application Publication
(10) Pub. No.: US 2026/0061729 A1
(43) Pub. Date: Mar. 5, 2026

(54) A BEVERAGE CAPSULE MADE OF MOULDED CELLULOSE WITH IMPROVED OXYGEN AND MOISTURE BARRIER

(71) Applicant: Société des Produits Nestlé S.A., Vevey (CH)

(72) Inventors: Michael Karlheinz Hausmann, Boudry (CH); Daniel Abegglen, Grandvaux (CH)

(73) Assignee: Société des Produits Nestlé S.A., Vevey (CH)

(21) Appl. No.: 19/106,425

(22) PCT Filed: Sep. 21, 2023
(86) PCT No.: PCT/EP2023/076038

§ 371 Date: Feb. 25, 2025

(30) Foreign Application Priority Data
Sep. 28, 2022 (EP) 22198432.1

(51) Int. Cl. B32B 23/08; B32B 27/30; B32B 37/12

(52) U.S. Cl. CPC B32B 23/08; B32B 27/306; B32B 37/12; B32B 2307/7163; B32B 2329/04; B32B 2439/60; B32B 2439/70

(57) ABSTRACT

A packaging item includes a body made of rigid or semi-rigid moulded cellulose pulp, and a multilayer film liner attached to the inner surface of the cellulose pulp body. The multilayer film liner includes, from outside to inside, a biodegradable outermost organic adhesive layer for attaching the multilayer film liner to the moulded cellulose pulp, an organic middle barrier layer including a modified alcohol-based polymer (BVOH), and an innermost biodegradable organic structural layer.

### FIELD OF THE INVENTION

The present invention concerns a capsule for beverage preparation that is recyclable in the paper recycling stream and comprises an outer body made of compressed cellulosic pulp, which is doubled with gas and moisture barrier liner tightly adhered to said pulp body.

### BACKGROUND OF THE INVENTION

Packaging items are traditionally made of various materials like glass and metal, but in recent decades, they have been manufactured predominantly out of plastic polymers which are inexpensive, easy to process, and light. However, more recently, due to increasing environmental awareness, technical progress is necessary to replace plastic by materials that can offer the same level of food safety and convenience, while being more recyclable or biodegradable, hence more environmentally friendly.

Such packaging items can be for example capsules and pods for beverage preparation in a beverage preparation machine, which are well known. Such packaging items can also be so-called “secondary packages”, for instance sachets that are wrapped around a primary packaging item.

Capsules are a convenient and clean approach to beverage consumption. In the following description, the generic term “capsule” will be used and encompasses single use packages for preparing beverages for human consumption by insertion in a beverage preparation machine that is adapted to inject a fluid-in principle hot water-into the package for mixing with an ingredient contained therein. Examples of such beverage packages are not limited to rigid capsules, but also comprise rigid, semi-rigid, or flexible pods, pads, cartridges of various types, and even sachet-type containers.

Typically, such capsules are manufactured from plastics such as polyolefins or biodegradable plastics, that are generally injected or thermoformed to obtain a cup that is filled with an ingredient and then closed with a membrane to close the capsule in a gas and moisture tight manner.

During beverage preparation, the capsule is inserted into a brewing chamber of a beverage preparation machine. The machine comprises water injection means, such as a needle or a set of blades designed to pierce through the thickness of the capsule body and inject water therein under pressure. Water mixes with the ingredient which produces a beverage. When water pressure increases and reaches a certain level, the closing membrane deflects outwardly and pierces onto piercing means of the beverage machine. When the membrane is pierced, the beverage can flow outside the capsule, towards a cup.

As mentioned above, in the recent period, awareness about the environment impact of packaging plastics increased, and there is a need for new packaging solutions that are either biodegradable after use, or recyclable, and in particular such that a used package can be either composted or recycled in a recycling stream that is adapted for paper or carton (“paper recycling stream”).

Therefore, beverage preparation capsules—amongst other packaging items—have recently been developed which are made of cellulosic fiber pulp (or “cellulose pulp” or “paper pulp”) which is moulded to form a rigid or semi-rigid capsule cup-shaped body defining a compartment for containing a beverage precursor ingredient such as roast and ground coffee. The cup-shaped body is closed by attaching (e.g. by sealing) a wall, for instance a membrane or a film to it.

In order to guarantee freshness of the beverage precursor ingredient over the lifetime of the capsule, and especially during storage until use, it is necessary to incorporate an oxygen and moisture barrier material to the cellulosic pulp (as well as to the closing membrane). The barrier material generally takes the form of a so-called “barrier liner” which is film having between five and ten individual layers attached one to another. The multilayer liner film is adhered to the internal surface of the pulp body (i.e. the surface turned towards the ingredient). Adhering the liner onto the pulp is done by thermoforming the two in a mould. Not all of the layers in the barrier liner bring barrier properties themselves: some of them are used as adhesion promoters between other barrier and structural layers of the liner. Such adhesion promoting layers are so-called “tie layers”.

Furthermore, it was found that certain properties of the polymers used for making the barrier film must be carefully chosen, such that the liner does not stretch without piercing, or does not delaminate from the moulded pulp material, during piercing of the capsule by the water injection means.

Generally, beverage preparation using pulp-based capsules with a barrier liner film, as described above, is a very promising way to reduce the environmental footprint of packages.

However, as the current trend is to develop packaging made of biodegradable materials, many of these structures fail to fulfil biodegradability in home-composting conditions. This is due to the fact that the structural materials are compounded and/or only partially biodegradable. This is particularly true for polymeric material used for making the barrier liner films.

Furthermore, current solutions for so-called “tie layers” in the barrier liners, are not biodegradable (or with limited biodegradability only) above a certain thickness limit, whereas tie layers used in barrier liners for capsules have a thickness which is above this limit and are therefore not properly biodegradable.

Additionally, the complexity of bringing together more than five layers of materials in a barrier liner film, with significant differences in thermal properties (melting point, viscosity, Melt Flow Index—or MFI—), is challenging from a manufacturing point of view.

The same technical challenges mentioned above in the case of beverage capsules, are posed to other types of packaging items such as secondary packages made of moulded pulp and comprising a barrier liner.

It is therefore an objective of the present invention to provide a technical solution to the challenges mentioned above in packaging items in general, and in beverage capsules in particular, that made of moulded pulp and comprise a barrier liner, and especially by providing a fully biodegradable (home compostable) packaging item that obviates the drawbacks mentioned above.

### SUMMARY OF THE INVENTION

The objective set out above is met with the present invention, with a packaging item comprising a body made of rigid or semi-rigid moulded cellulose pulp, characterized in that said item further comprises a multilayer film liner attached to the inner surface of the cellulose pulp body, said liner comprising from outside to inside (“inside” being the portion of the liner in contact with the product, whereas the “outside” is the portion of the liner in contact with the cellulosic body of the packaging item):
(i) an outermost organic adhesive layer for attaching the liner to the moulded cellulose pulp, said adhesive layer comprising a biodegradable polymer selected within the list of: polybutylene succinate (PBSA/bioPBS), polybutylene adipate terephthalate (PBAT), starch, cellulose derivates, polylactic acid (PLA), polyhydroxyalcanoates (PHA), or a combination thereof, said outermost layer having a thickness comprised between 10 and 100 μm, an elongation at break comprised between 10% and 800%, a melt flow rate (MFR) comprised between 2 and 4 when measured at 150° C. during 10 minutes with a pressure of 2.16 kg, and said layer also having a melting point temperature comprised below 80° C.,
(ii) an organic middle barrier layer comprising a butenediol vinyl alcohol copolymer (BVOH) grafted with maleic anhydride, a polyglycolic acid (PGA) grafted with maleic anhydride, or a mixture thereof, and having a melting point temperature comprised between 180° C. and 230° C. and a thickness comprised between 1 and 20 μm,
(iii) an innermost organic structural layer comprising a biodegradable polymer selected within the list of: polybutylene succinate (PBSA), polybutylene adipate terephthalate (PBAT), starch, cellulose derivates, polylactic acid (PLA), polyhydroxyalcanoates (PHA) or a combination thereof, said layer having a thickness comprised between 10 and 100 μm, an elongation at break comprised between 10% and 1000%, a melt flow rate (MFR) comprised between 4 and 10 when measured at 190° C. during 10 minutes with a pressure of 2.16 kg, and said structural layer having also a melting point temperature comprised between 110° C. and 180° C.

The capsule according to the present invention makes it possible to remove the tie layers from the barrier liner structure, hence rendering the whole material biodegradable in home-compositing conditions. The resulting barrier liner comprises three layers only, which is also an advantage in terms of manufacturing complexity. The reduction of the barrier liner complexity to only three layers was made possible by the surprising discovery by the inventors that by modifying the BVOH barrier layer and grafting it with maleic anhydrides groups, its compatibility with PBS-based resins, which is the main constituent of the adjacent external and adhesive layers, is greatly improved. As a result of this increased chemical—hence mechanical—compatibility, the use of intermediate tie layers is no longer necessary.

Furthermore, and interestingly, the polymers that are suitable for the invention are biodegradable polymers, preferably home compostable polymers. Home compostability is now well defined on a national level and mainly based on international standard EN 13432; therefore, they do not require to be further defined in-depth in the present specification. Materials or products compliant with these standards can be recognized by a conformity mark stating their home compostability. Some examples of home compostability certifications at a national level include, but are not limited to, the following. The certifier TÜV AUSTRIA BELGIUM offers such a home compostability certification scheme, and DIN CERTCO offers a certification for home compostability according to the Australian standard AS 5810. Italy has a national standard for composting at ambient temperature, UNI 11183:2006. In November 2015, the French Standard “NF T 51-800 Plastics—Specifications for plastics suitable for home composting” was introduced. This standard is covered in the DIN CERTCO scheme.

According to the principle of the invention, a multilayer liner is provided with a barrier (to oxygen and/or moisture) as a middle layer. The physical characteristics of the innermost and outermost layers are carefully selected:
the outermost layer in contact with the pulp has a low melting point temperature (below 80° C.) which brings high cohesion to the pulp; this is due to the fact that during thermoforming process of the liner to the pulp body, when temperature increases, the polymer constitutive of the outermost layer flows rapidly and with a low viscosity between the pulp fibers of the body, and impregnates the pulp; then, when temperature decreases after the thermoforming step, the polymer layer of the liner hardens and polymer is completely intricated between the pulp fibers, such that it is impossible to delaminate the liner from the pulp body, and in addition
the innermost layer in contact with the beverage ingredient has a high melting point (above 110° C.). A higher melting point than the outermost layer guarantees that during thermo-forming of the liner with the pulp, said outermost layer melts very fast and in a perfectly liquid state due its melting point which is well below the usual thermo-forming temperature, such that it flows in between the cellulosic fibers of the pulp, and such that when it cools down after thermoforming, the material constitutive of said outermost layer is intricated with the pulp cellulosic fibers and adheres to them. At the same time, the innermost layer does not melt during the thermo-forming process step, due to its higher melting point (which is above the usual thermo-forming temperature), such that it separates easily from the thermo-form plug when the thermoforming of the liner to the pulp is completed and the thermo-forming mould is open.

By “liner” it is meant a monolayer or multilayer film that is obtained by extrusion-blowing, or extrusion-lamination, or cast-extrusion.

A monolayer or multilayer liner applied to the pulp substrate is different from a monolayer or multilayer obtained by coating the pulp substrate. Coating a barrier layer onto a moulded pulp substrate is challenging because the surface of the moulded pulp is rough and uneven. As a result, it is necessary to coat a high thickness of a preparation surface coating in order to smoothen the pulp surface before a barrier layer can be coated. If the surface is not smoothened, there is a risk that the barrier layer may be applied in an uneven manner and such that some zones are not sufficiently coated, hence impairing the barrier properties of the whole item. The application of a liner does not pose such a problem because all layers are preformed in an even manner, and such that the barrier layer is homogeneous across the entire surface of said liner before the latter is applied to the moulded pulp substrate. The barrier quality is therefore guaranteed across the entire surface of the resulting item and requires less polymeric material than a coating.

Furthermore, a coating is normally applied on a flat sheet of substrate material. However, a capsule has a tridimensional geometry which makes it difficult, if not impossible to coat with a thin molten polymer layer. Moreover, the challenges related to coating on fiber-based materials are indeed related to the surface quality (rough or smooth), quality which is linked to the presence of loose fibres in the coating/fiber interface. These loose fibres will lead to pin holes through which water vapor, and oxygen can migrate. In case of a thermoforming lamination, this problem is avoided.

In a first embodiment of the present invention, the packaging item is a secondary packaging for enclosing a primary packaging, said secondary packaging being preferably selected within the list of for example: sachet, gusset wrap, tube, bag, box, brick, container, or a combination thereof.

In a second embodiment of the present invention, the packaging item is a capsule for beverage preparation, comprising a cup-shaped body, and at least one closing membrane attached to said body, said body and said at least one membrane defining a closed ingredient compartment, said capsule being adapted to be pierced by water injection means of a beverage preparation machine for injecting water under pressure in the compartment, for preparing a beverage therein.

Preferably, the cup-shaped body of said capsule comprises a peripheral rim onto which the closing membrane is attached.

Furthermore, the closing membrane can advantageously be made of an extrusion coated paper, a fiber-spinning coated paper, or a polymer film comprising a compatible polymer material.

The ingredient inside the compartment of a beverage capsule according to the second embodiment of the invention is preferably roast and ground coffee.

Whatever the embodiment of the invention, the outermost, innermost, and barrier layers are preferably co-extruded layers.

Furthermore, the polymer of the innermost layer can be an annealed polymer which provides increased mechanical and structural properties to the liner.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic perspective view of a partially cut capsule according to the first embodiment of the invention;

FIG. 2 is a schematic cut view of a multilayer liner according to the invention;

FIGS. 3, 4, 5A, 5B, 5C are schematic views of the different steps of attaching a barrier liner to a moulded pulp cup-shaped body according to the invention.

### DETAILED DESCRIPTION OF THE INVENTION

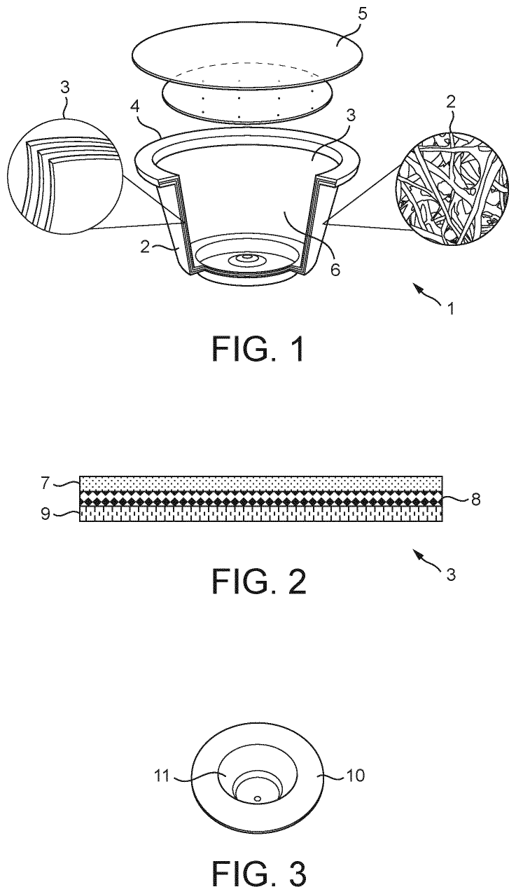

As illustrated in FIG. 1, a first embodiment of the present invention relates to a packaging item which is a beverage preparation capsule 1. The beverage capsule 1 comprises a cup-shaped capsule body 2 covered on its inner surface by an oxygen and barrier liner 3. In FIG. 1, the liner 3 is also represented in an enlarged view on the left, that depicts its three constitutive layers. The capsule body 2 further comprises a peripheral rim 4 that surrounds an opening, said opening being closed by a closing membrane 5 that is sealed onto the rim 4. The capsule body closed by the membrane 5 defines a compartment 6 for a roast and ground coffee ingredient contained therein.

As shown in an enlarged partial view, on the right-hand side of FIG. 1, the cup-shaped capsule body 2 is manufactured out of a moulded cellulose pulp. In the enlarged partial view of FIG. 1 is shown the imbrication of the cellulose fibres.

The barrier liner 3 is a multi-layer film, an embodiment of which is illustrated in FIG. 2. In this embodiment, the liner comprises the three following layers attached one to another. The layers are described from the outermost layer of the barrier liner 3 (i.e. the layer which is adjacent to the cellulosic moulded pulp capsule body), towards the innermost layer which is the layer in contact with the product or ingredient contained inside the capsule.

First, the liner 3 comprises an outermost adhesive organic polymer layer 7, made of a polybutylene adipate terephthalate (PBAT) based formulation. This outermost layer has a thickness of 17 μm, and an elongation at break of 600% and serves as an adhesive to the pulp. It also features a melt flow rate (MFR) of 3 (measured at 150° C. during 10 minutes with a pressure of 2.16 kg), and a melting point temperature of 75° C.

As a core layer located in the middle of the multilayer liner structure is a barrier layer 8 made of butenediol vinyl alcohol copolymer (BVOH) modified by grafting maleic anhydride groups to the BVOH molecules, and having a melting point temperature comprised of 200° C. and a thickness of 8 μm. This barrier layer provides barrier against oxygen and moisture transfer between the outside atmosphere and the capsule compartment.

Lastly, the liner in this embodiment depicted in FIG. 2 comprises an innermost organic polymer structure layer 9 made of polybutylene adipate terephthalate (PBAT) based formulation. This innermost layer has a thickness of 17 μm, and an elongation at break of 177%. It also features a melt flow rate (MFR) of 6 measured at 190° C. during 10 minutes with a pressure of 2.16 kg. This layer has a melting point temperature of 115° C.

Generally, the adhesive layer 7 and structure layer 9 are biopolymers selected from the list of: PBSA, PBAT, starch, cellulose derivatives, PLA, PHAs and combinations thereof. The outermost adhesive layer 7 has a lower melting temperature of at least 10° C., preferentially 20° C. compared to the structural layer.

As described above, a butenediol vinyl alcohol copolymer (BVOH) with improved affinity to biopolyesters is used in the middle barrier organic layer 8. The improved affinity of the BVOH used therein with biopolyesters is due to the fact that the BVOH polymer molecules are grafted with maleic anhydrides groups, hence increasing its compatibility with PBS-based resins, which is the main constituent of the adjacent innermost and outermost layers.

The BVOH barrier layer 8 is co-extruded together with the adhesive and structural layers 7, 9 into a triple layered film. This modified BVOH allows to have sufficient adhesion between both exterior layers to allow the material to be extruded, handled and thermoformed.

Alternatively, this layer can also be a modified (i.e. grafted with maleic anhydride) polyglycolic acid (PGA) polymer, instead of BVOH.

The thicknesses of each layer in the liner 3 according to the present invention vary from one layer to another, as follows.

The adhesive layer 7 has a thickness comprised between 10 and 100 μm, preferably between 10 and 50 μm, and in one particular example, it has a thickness of 22 μm.

The barrier layer 8 has a thickness comprised between 1 and 20 μm, and in one particular example, it has a thickness of 8 μm.

The structural layer 9 has a thickness comprised between 10 and 100 μm, preferably between 10 and 50 μm, and in one particular example, it has a thickness of 40 μm.

The liner structure can be symmetric or asymmetric in thickness, meaning that the adhesive layer 7 and structural layer 9 can have similar or dissimilar thicknesses.

Typical values for barrier can vary between 0.05 to 0.8 cc/m²/day/atm, preferentially below 0.1 cc/m²/day/atm.

The advantage of asymmetric structures is that warpage and folding of the liner is reduced. This simplifies post processing such as thermoforming and film handling.

The capsule 1 according to the first embodiment of the present invention is manufactured with the following steps, in order.

As illustrated in FIG. 3, a capsule cup 10 is first moulded from a dry or wet (preferably wet) pulp mixture. Moulding cellulose pulp is known in the art already and will not be described in more detail in the present description. The pulp cup 10 has an opening 11 into which a roast and ground coffee ingredient can be filled (not illustrated).

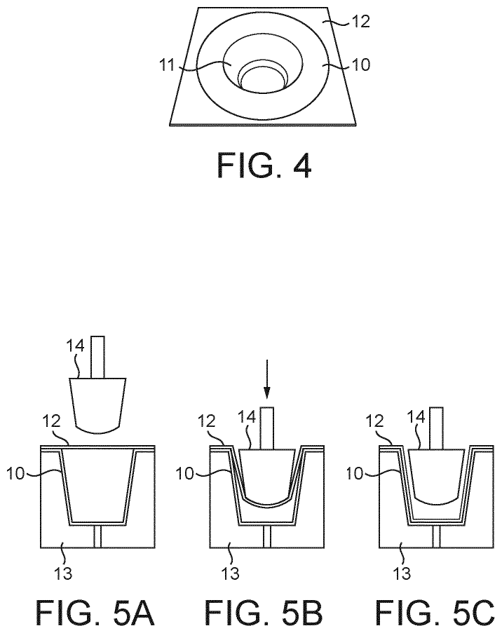

The barrier liner film 3 is then provided as a flat sheet 12 and placed over the opening 11 of the pulp cup 10, while said cup 10 is placed in a mould 13, as depicted in FIGS. 4 and 5A and heated.

Then, as shown in FIG. 5B, a thermoforming plunger 14 is applied onto the surface of the flat sheet 12, which is moved towards the interior of the cup 10, such that the barrier liner sheet is pushed into the vicinity of the cup's interior, until said liner is fully attached to the pulp cup surface as shown in FIG. 5C. The technique of attaching the barrier liner sheet 12 to the surface of the pulp cup 10 is largely based on plug assist thermoforming, which is known in the art already and will not be described in more detail in the present description.

Once the attachment process of the barrier liner sheet 12 onto the inside surface of the pulp cup 10 is terminated, the peripheral rim 4 is trimmed (i.e. cut to the right diameter) so that an empty pulp capsule with barrier properties is obtained as illustrated in FIG. 1, which comprises an opening through which a coffee powder is filled. Then, the filled capsule is closed by sealing the membrane 5 onto the rim 4 of said capsule.

Typical temperatures for thermoforming the liner into the moulded pulp capsule body are within a range comprised between 110° C. to 190° C., for lower and respectively upper heating sources. The plug profile has to be properly adapted to the capsule profile to ensure homogeneous liner material distribution and deformation.

The final thermoformed capsule has a homogeneously distributed liner that shows good adhesion to the molded pulp surface. Typical barrier values for the capsule and liner structure, varies between 0.001 and 0.01 cc/pack/day/atm, preferably below 0.009 cc/pack/day/atm, more preferably below 0.0033 cc/pack/day/atm.

The characteristics of the invention described above in reference to a beverage capsule, also apply to another type of embodiment of the invention, whereby the packaging item is not a beverage capsule, but rather a secondary packaging, such as for instance a moulded pulp carton for containing beverages, or a wrapping sachet for containing such products as powder food products. Of course, in each individual case, known manufacturing techniques to assemble the barrier liner to the moulded pulp component of the capsule can be adapted.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A packaging item comprising a body made of rigid or semi-rigid moulded cellulose pulp, and a multilayer film liner attached to an inner surface of the cellulose pulp body, said multilayer film liner comprising from outside to inside:
(i) an outermost organic adhesive layer for attaching the multilayer film liner to the moulded cellulose pulp, said outermost organic adhesive layer comprising a biodegradable polymer selected from the group consisting of polybutylene succinate (PBSA/bioPBS), polybutylene adipate terephthalate (PBAT), starch, cellulose derivates, polylactic acid (PLA), polyhydroxyalcanoates (PHA), and a combination thereof, said outermost organic adhesive layer having:
a thickness between 10 and 100 μm,
an elongation at break between 10% and 800%,
a melt flow rate (MFR) between 2 and 4 when measured at 150° C. during 10 minutes with a pressure of 2.16 kg, and
a melting point temperature below 80° C.,
(ii) an organic middle barrier layer comprising a butenediol vinyl alcohol copolymer (BVOH) grafted with maleic anhydride, a polyglycolic acid (PGA) grafted with maleic anhydride, or a mixture thereof, and having:
a melting point temperature between 180° C. and 230° C., and a thickness between 1 and 20 μm, and
(iii) an innermost organic structural layer comprising a biodegradable polymer selected from the group consisting of polybutylene succinate (PBSA), polybutylene adipate terephthalate (PBAT), starch, cellulose derivates, polylactic acid (PLA), polyhydroxyalcanoates (PHA) and a combination thereof, said innermost organic structural layer having:
a thickness between 10 and 100 μm,
an elongation at break between 10% and 1000%,
a melt flow rate (MFR) between 4 and 10 when measured at 190° C. during 10 minutes with a pressure of 2.16 kg, and
a melting point temperature between 110° C. and 180° C..

2. The packaging item according to claim 1, which is a secondary packaging for enclosing a primary packaging, said secondary packaging being selected from the group consisting of sachet, gusset wrap, tube, bag, box, brick, container, and a combination thereof.

3. The packaging item according to claim 1, which is a capsule for beverage preparation, comprising a cup-shaped body, and at least one closing membrane attached to said cup-shaped body,
said cup-shaped body and said at least one closing membrane defining a closed ingredient compartment,
said capsule being adapted to be pierced by water injection means of a beverage preparation machine for injecting water under pressure in the closed ingredient compartment, for preparing a beverage therein.

4. The packaging item according to claim 3, wherein said cup-shaped body comprises a peripheral rim onto which the at least one closing membrane is attached.

5. The packaging item according to claim 3, wherein the at least one closing membrane is made of an extrusion coated paper, a fiber-spinning coated paper, or a polymer film comprising a compatible polymer material.

6. The packaging item according to claim 3, wherein an ingredient inside said closed ingredient compartment is roast and ground coffee.

7. The packaging item according to claim 1, wherein at least the outermost organic adhesive layer, the innermost organic structural layer and the organic middle barrier layer are co-extruded layers.

8. The packaging item according to claim 1, wherein the biodegradable polymer of the innermost organic structural layer is an annealed polymer.
